(19) United States
(12) Patent Application Publication
(10) Pub. No.: US 2004/0107159 A1
(43) Pub. Date: Jun. 3, 2004

(54) SYSTEM AND METHOD FOR RANKING MESSAGE HEADERS IN AN ELECTRONIC BULLETIN BOARD SYSTEM

(75) Inventor: Brian Heil, New York, NY (US)

Correspondence Address: DALINA LAW GROUP, P.C., 7910 IVANHOE AVE. #325, LA JOLLA, CA, 92037, US

(73) Assignee: PROXYMATTERS.COM LLC., New York, NY (US)

(21) Appl. No.: 10/707,256

(22) Filed: Dec. 1, 2003

(51) Int. Cl. G06F 17/60

(52) U.S. Cl. 705/37

(57) ABSTRACT

One or more embodiments of the invention are directed to a software program and computer system configured to enable users to establish or modify message order placement on a Bulletin Board System (BBS) by purchasing or bidding for message placement. Bidding can occur up to a preset amount or without upper limit (e.g., with reserve or without reserve). BBS operators benefit through the generation of higher revenues and garner increased user participation due to this ordering. The ordering of messages by the amount paid for the message gives users quicker access to more important messages, allows user messages with higher importance to be posted in a more accessible setting and hence increases the membership of the BBS since less searching is required than in a traditional BBS. Revenue is not limited to paid placement but can also be generated based on each message viewing, either by charging users for viewing the body of a message and/or paying users for the number of viewings of their messages, thereby rewarding good posts which in turn generates higher membership in the BBS and therefore higher profits. In addition, for an extra fee, extended text message headers can be displayed thereby giving users an incentive to read the message. The system may allow for fixed duration, weekend, holiday or other calendar based placements to be purchased. Embodiments of the invention may utilize scaleable architectures to process any number of users and/or messages, further increasing the ability of the system to generate revenue.

### BACKGROUND OF INVENTION

1. Field of the Invention

One or more embodiments of the invention have applicability in the field of computer software or hardware. More particularly, the invention is directed to a method and apparatus for configuring such computer software or hardware to arrange message headers in an electronic bulletin board system.

2. Description of the Related Art

A bulletin board system (BBS) otherwise known as an electronic bulletin board, online bulletin board, electronic message board, newsgroup, or discussion group is a computerized forum for exchanging messages between multiple users over a computer network. The first BBS was named the Computerized Bulletin Board System (CBBS) and was created in 1978 by Christensen and Suess. CBBS became the first non-military computer hosted community. In the early 1980s, the BBS formed the primary online community of the pre-World Wide Web era. Compared to other communications mediums, BBSs remain remarkably primitive as they have failed to evolve significantly in sophistication and/or ease of use over the years.

Generally, BBSs permit users to view a list of message headers and by asserting a command associated with each message header allow users to see each individual message. The messages may be related to any endeavor. Some BBSs contain a tree view or list as the navigational medium by which the messages may be hierarchically traversed. Posting a message to a BBS is performed by composing the message in a browser window or other text editor and uploading the message to the BBS. Many BBSs screen the messages for undesirable words or other content and then display the post in the navigational list so that other users can access the message. The messages are generally indexed by date, author or topic. Many BBS implementations possess search capabilities so that linear traversal of the entire list is not necessary although search result lists must still be linearly traversed.

Current BBSs are not user friendly. When first viewing a topic or thread, many message headers which may have relatively little significance must be traversed irregardless of the desirability of the content of the message. This is due to the fact that the message headers are generally listed by author, subject and date. The message headers are not ranked for higher placement in the list according to any other criteria. Thus users must often engage in the time consuming and burdensome process of browsing through thousands of message headers in order to find a message of significance. Because there are no known mechanisms for allowing users to self-determine the rankings of the message headers, the user is forced into the linear traversal paradigm discussed above. Such a cumbersome process detracts from the utility of the BBS and ignores the needs of the users.

The limitations of current BBSs inhibit the formation of electronic communities based on the sharing and learning of information content. In other words, the apparent initial promise of the Internet to bring together thousands of users so they can collectively share information, opinions, insights, lessons, etc., has not been effectively realized to date. In large part this is due to a combination of factors, including the fact that information content from users and other sources is difficult to locate. In short, the Internet contains an abundance of data that would be of interest to broad classes of users. However, since users are forced to locate such data using a largely manual review process, the data is widely underutilized. In essence much of the data never becomes truly useable information. Accordingly, electronic communities where information is easily located and shared have not become commonplace. Existing communities would be considerably enhanced by a system that intelligently gathers and stores information from the community members, and then permits users in such communities to be able to easily, flexibly and controllably glean and share selected insight from the experience, opinions, actions and facts of other users.

Current BBSs do not provide a mechanism for the service provider to generate additional revenue beyond the rudimentary systems of subscription revenues and advertising. While some service providers require users to pay subscriptions fees to read or leave messages, the primary source of revenue for service providers is advertising billboards or links that surround the BBS on the user's interface. In other words, the BBS is provided free to all users. This lack of monetization of the users is a missed revenue opportunity by the service provider that, up to this point, has not been avoidable due to the non-existence of any mechanism that could effectively monetize the user in a manner consistent with the users' desires to use the BBS. Although a few prior art systems attempt to enhance the usability of message board systems, such systems have failed to generate a mechanism for achieving adequate monetization. Some of these systems are discussed below.

In U.S. Pat. No. 6,571,234 issued to Knight et al., an online electronic message board is described that is managed by customized search robots. The robots interact with a set of users to obtain and post messages in groupings and classifications that reflect the collective interests of the users. This system attempts to pre-classify and index the information for the users without user payment for a higher ranking.

In U.S. Pat. No. 6,515,681 issued to Knight, an online message board user interface is described for facilitating user interactions with the online message board. The interface provides multiple levels of filtering in an attempt to allow users to more rapidly locate relevant subject matter. The system described in Knight does not contemplate rankings the information based upon user payment or some other scheme.

In U.S. Pat. No. 6,438,632 issued to Kikugawa, an electronic bulletin board system is described that checks user messages for posting-prohibited words. The system rejects messages that contain these types of words. The system does not contemplate ranking messages in any way.

In U.S. Pat. No. 6,363,427 issued to Teibel et al., an electronic message exchange system is described that compiles messages from diverse servers into one list of messages. This system does not contemplate ranking messages in any way.

In U.S. Pat. No. 6,202,058 issued to Rose et al., a system for ranking information objects is described that ranks information according to a prediction of the likely degree of relevance to the user's interests. This is accomplished by comparing a user profile to the information and producing a ranked result for each document. The user correlation data is obtained from feedback information provided by users when they retrieve the information. Therefore, if a given user finds a type of information particularly relevant, then a document containing that type of information is given a higher ranking. There is no contemplation of paying for a higher ranking.

In U.S. Patent Publication Number 20030088568 applied for by Matsunaga et al., an electronic bulleting board system having a translation function is described. The system feeds posted messages into a translation machine prior to displaying the translated messages. This system does not contemplate ranking messages in any way.

In U.S. Patent Publication Number 20020047868 applied for by Miyazawa an electronic bulletin board system is described that allows users to communicate without email addresses by location specific bulletin board at a given meeting place. This system facilitates meetings at conventions where a given user is desirous of leaving a message for another user. An icon based message, possibly with text, is left on the bulletin board that needs only to be understandable by the user receiving the message. In this way, users can communicate without using email addresses. There is no contemplation of user payment for a higher ranking.

Some search engines on the internet utilize ranking systems based upon payment. Since the results are always from the result of a search, there is no structured forum that allows users to transmit or respond to posts from other users. The search engines with paid placement capabilities are therefore unusable for ranking the messages in a thread. Some examples of search engine patents comprising paid placement are listed below.

In U.S. Pat. No. 6,269,361 issued to Davis et al., a system is described for influencing the position on a web search result list. The ranking of results is determined by a bid amount and allows users to effectively position their listings in the results listing based on specified search phrases giving the highest placement to the highest bidder. The system requires a search to be performed by the user and there is no contemplation of ranking messages in a BBS in this disclosure.

In U.S. Pat. No. 6,078,866 issued to Buck et al., an Internet site searching and listing service based on monetary ranking is described. This system contains a title and description for each listing and a URL where the listing can be found and in addition, a monetary value paid by the user to list the site. The server returns a ranked list of results based on this monetary value. The system requires a search to be performed by the user and there is no contemplation of ranking messages in a BBS in this disclosure.

In U.S. Pat. No. 6,631,372 issued to Graham, a search engine which ranks search results based on sales data is described. In some embodiments, the system uses merchant bidding to alter the weights of the search results. The system requires a search to be performed by the user and does not contemplate ranking messages in a BBS.

Given that each of the known references described above are lacking in a mechanism for monetizing message boards, it is evident that a need exists for an improved BBS that is able to derive significant revenue from its user base.

### SUMMARY OF INVENTION

One or more embodiments of the invention are directed to a software program and computer system configured to enable users to establish and/or modify message order placement on a Bulletin Board System (BBS) by purchasing or bidding for message placement. Bidding can occur up to a preset amount or without upper limit (e.g., with reserve or without reserve). BBS operators benefit through the generation of higher revenues and garner increased user participation due to this ordering. The ordering of messages by the amount paid for the message gives users quicker access to more important messages, allows user messages with higher importance to be posted in a more accessible setting and hence increases the membership of the BBS since less searching is required than in a traditional BBS. Revenue is not limited to paid placement but can also be generated based on the viewing of each message. For instance, the system may be configured to charge users for viewing the body of a message and/or pay users for the number of viewings of their messages, thereby rewarding good posts which in turn can generate higher membership in the BBS and therefore higher revenue. In addition, for an extra fee, extended text message headers (e.g., a partial view of the message contents) can be displayed thereby giving users an incentive to read the message. The system may also allow for fixed duration, weekend, holiday or other calendar based placements to be purchased. Embodiments of the invention may utilize scaleable architectures to process any number of users and/or messages, further increasing the ability of the system to generate revenue.

The system comprises the logic required to exchange message information to computers over a communications network. Embodiments of the system residing on the internet for example may comprise a server (e.g., a web server) for processing message exchanges between the system and computers residing on the network. In addition, embodiments of the system may employ commercial databases in order to store message related information. Business logic for posting, viewing, deleting, searching, logging in, logging out, paying for placement, bidding for placement or any other system related function may be implemented via Java servlets, CGI, Perl, .NET or any other programming methodology capable of delivering the content of the messages for viewing on any user device capable of communicating with the system.

After the system is initialized and running, user based commands drive content from the system to the user's computer. The user's device may comprise a cell phone, a PDA, a Personal Computer (PC) or any other device capable of viewing messages hosted on the BBS.

User interactions with the system may include logging in or out, possibly through use of cookies or by any other means in order to identify the user including but not limited to email addresses in order to allow the user to post messages with the system. After a message is posted to the system, other users can view the messages. The user may optionally be required to log into the system before viewing a posted message or messages. The user may desire to search for key words or traverse the topics or threads in the system. Generally, only the BBS moderator or other authorized users are allowed to delete messages.

An embodiment of the invention allows users to pay for a given placement of the message within the system and possible to be charged for viewing messages or possibly allowing for the user that posted a message to be charged for each occurrence of a view of a message. Optionally, the user that posted the message may earn money for each message viewed. Other embodiments allow for large text length message headers to be paid for. The system may allow for fixed duration, weekend, holiday or other calendar based placements to be purchased. Portals may integrate and pay for use of the system in certain embodiments of the invention.

Multiple viewing areas for a given message header list may be utilized wherein the paid placement message headers appear in a separate area with regards to the non-paid message headers. The term message header as used herein may include a topic or general subject heading and/or a partial or complete view of the message contents. Other embodiments of the invention may use one area for displaying all messages with highest paid messages being placed at a viewable area of the message display region. The system is also capable of entertaining bids for placement areas and alerting users that their placements have changed based on other bids. In addition, the system is also capable of optionally showing the actual bid or payment amounts along with author, subject and date/time metadata related to a message. Embodiments utilizing two message header viewing areas categorized by, for example, “for” and “against” may be used in applications directed towards Proxy votes or other election issues. Other embodiments may employ three message header viewing areas categorized by, for example, “yes”, “no” or “maybe” in order for users to place their various viewpoints on a particular issue or election. Other embodiments of the invention may utilize higher numbers of columns for example a BBS for college students with “Freshman”, “Sophomore”, “Junior” and “Senior” viewing areas. Single or multiple message header viewing areas may include message headers regarding auction items and classified ads for given item types or across all items, job or project listings across job type or across all job/projects, resume sites for users looking for employment or message headers relating to any other purpose or endeavor. Although certain message subjects are used herein as examples, the invention is not limited to these specific subjects and can be adapted for use across many diverse subjects.

### BRIEF DESCRIPTION OF DRAWINGS

FIG. 1 illustrates a block diagram of the physical components of an embodiment of the invention.

FIG. 2 illustrates a graphical user interface utilized in an embodiment of the invention.

FIG. 3 illustrates a business logic block diagram of the processing for interacting with a user of the system.

FIG. 4 illustrates a business logic block diagram of the method of operation of the system from the user point of view.

FIG. 5 illustrates an embodiment of a graphical user interface utilized in the system.

### DETAILED DESCRIPTION

Embodiments of the invention relate to a system and method for ranking information in electronic bulletin board systems. In the following exemplary description, numerous specific details are set forth to provide a more thorough description of embodiments of the invention. It will be apparent, however, to one skilled in the art, that the invention may be practiced without these specific details. In other instances, well known features have not been described in detail so as not to obscure the invention.

One or more embodiments of the invention are directed to a software program and computer system configured to enable users to establish and/or modify message order placement on a Bulletin Board System (BBS) by purchasing or bidding for message placement. Bidding can occur up to a preset amount or without upper limits (e.g., with reserve or without reserve).

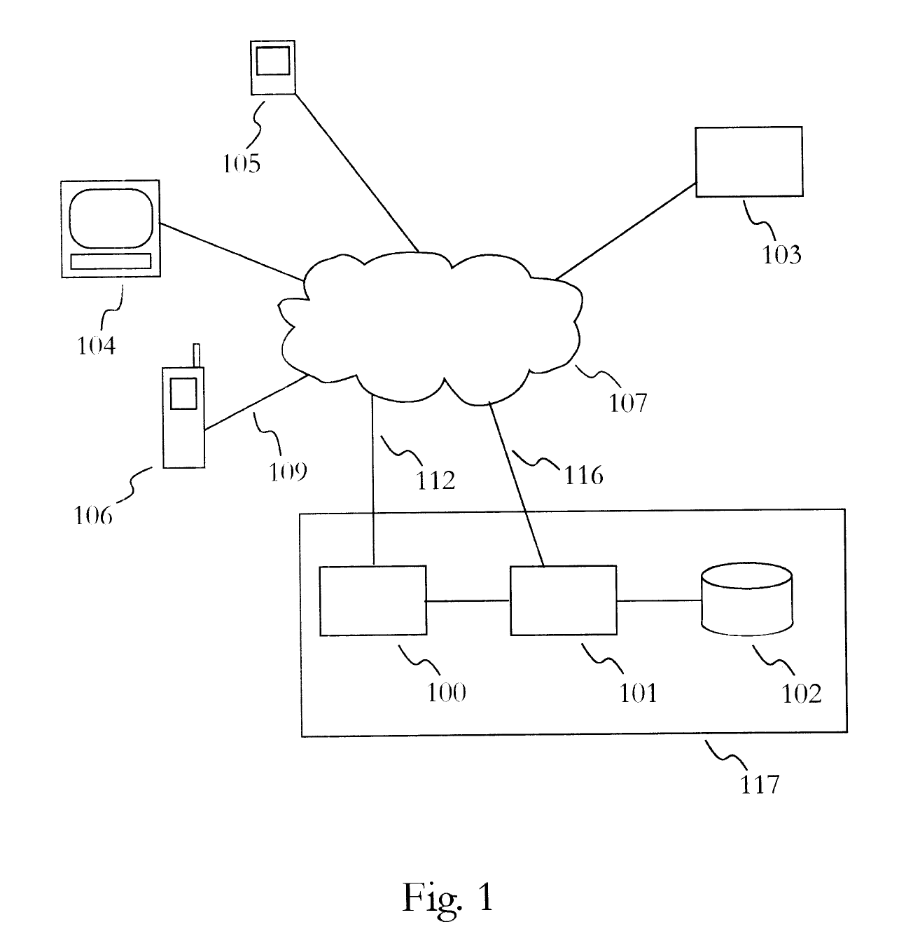

FIG. 1 illustrates a block diagram of the physical components of an embodiment of the invention. Human Interface Devices (HIDs) 104, 105 and 106 are utilized by the user in order to view, sort, search and post messages to the BBS. In addition, purchasing or bidding on a placement for a post is accomplished via HIDs 104, 105 and 106. HID 104 may comprise a laptop or desktop computer system whereas HID 105 may comprise a PDA or other personal digital device capable of communicating over network 107 to ranking BBS 117. HID 106 may comprise a cell phone or other communication device capable of sending and receiving information and commands to ranking BBS 117. HID 106 may communicate via wireless connection 109, via direct link to a hardwire modem or via any other mechanism such as but not limited to Bluetooth. Network 107 may comprise the internet or any other network capable of sending and receiving information and commands between HIDs 104, 105, 106 and ranking BBS 117. Ranking BBS 117 may comprise web server 100, optional application server 101 and database server 102. In addition, components 100, 101 and 102 may be configured in clusters in order to scale to any size desired. Incoming requests for information and commands arrive at web server 100 over network connection 112. An embodiment of the invention without application server 101 is configured by placing transactional code on web server 100 for obtaining payments based on fixed priced or winning bid amounts. Application server 101 may communicate with external credit card processing server 103 over network 107 via network connection 116. This enables the application server to utilize a separate network connection possibly behind a DMZ or secondary fire wall (not shown for simplicity) located between network connection 116 and application server 101 in order to secure information related to credit cards or personal information of the users of the system. All network connections may utilize non-encrypted or encrypted communications channels.

Operation of the system in one embodiment of the invention is as follows. HID 104 for example is directed by the user to contact ranking BBS 117 for a list of topics. Ranking BBS 117 returns the list of topics hosted. When the user is presented with the list of topics, the user may select a topic and view the message headers of the messages in the topic. Alternatively or in addition the user may direct the system to search on a phrase or word in order to return specific message headers. An embodiment of the system returns at least one list of message headers. When a message header in the list is selected the message text appears in the window. The user may then traverse the message header list, search within the list or post a message with regards to an existing message in the form of a reply or post a message without regards to an existing message in the form of a new thread post. Messages may optionally include a purchase amount or bid amount in order to establish the ranking of the post.

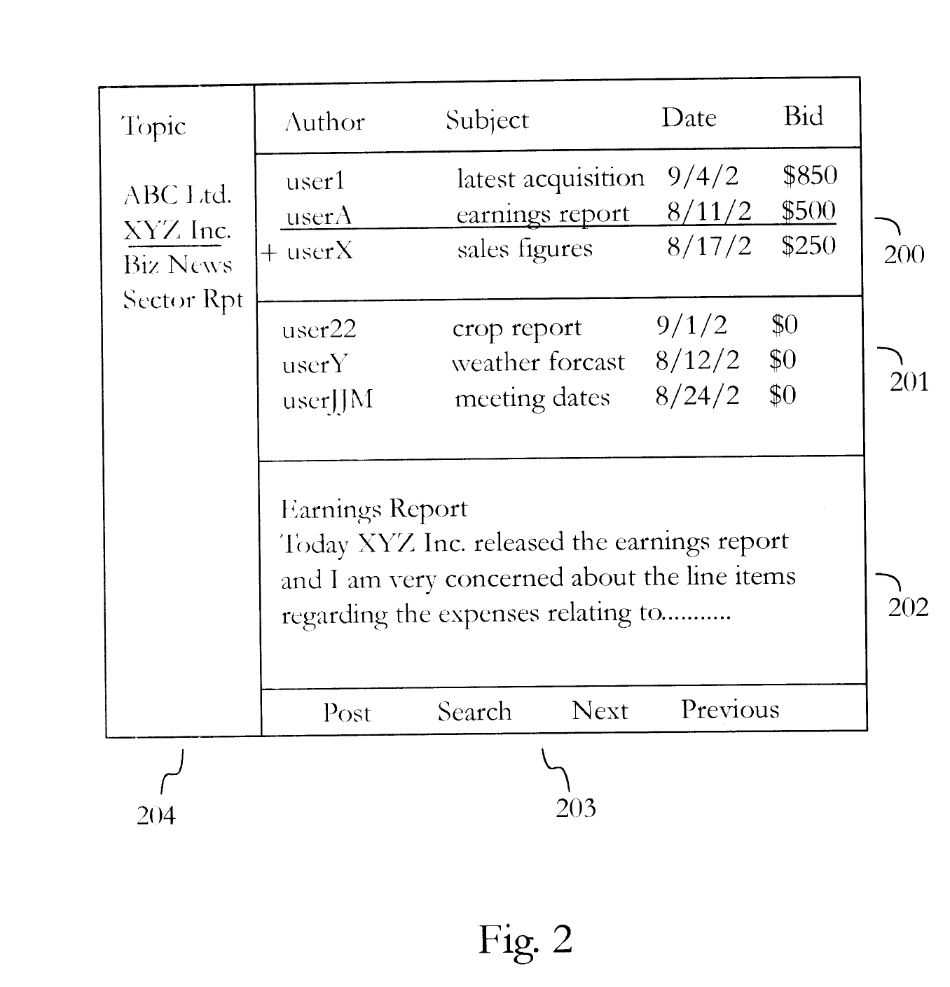

FIG. 2 illustrates a graphical user interface utilized in an embodiment of the invention. Topic list 204 displays the topics hosted on the system. In this example view, the second topic, “XYZ Inc.” is underlined to depict selection of the topic. Embodiments of the invention may use any methodology of showing a selection including but not limited to highlighting the selection. Selection of a topic in topic list 204 displays the message headers for the selected topic in at least one viewing area. Viewing area 200 shows the message headers with default ordering of highest bid shown in the most prominent viewing location. An embodiment of the invention hiding bid amounts is readily constructed by disabling the sending of this information from ranking BBS 117. Optional viewing area 201 shows the message headers posted by users not wishing to pay for higher listings. The divider between viewing area 200 and viewing area 201 may be adjustable in certain embodiments of the invention comprising graphical components capable of user adjustment. If optional viewing area 201 is omitted, message headers with no bid amount may be displayed in a less prominent area than message headers that have a bid amount, for example at the bottom of the list or viewing area. Assertion of the “Author”, “Subject”, “Date” or “Bid” message header column headers may sort the list by the asserted column header. Since the message headers in viewing area 200 and optional viewing area 201 may comprise associated post message headers, in effect these message headers may be further traversed as seen in the third line in viewing area 200 with a “+” symbol denoting the capability of further traversal. Selection of the “+” symbol may display additional message headers indented beneath and associated with the given message header. If one of these message headers has a higher bid amount, then the “+” may show the exploded list with the highest bid amount message somewhere in the middle of the exploded list. This means that the individual threads or message header list groups shown in viewing area 200 may not default to the first time ordered message being displayed initially depending on the bid amounts in the thread. Selection of a particular message header as is shown in viewing area 200 on the second line (“userA . . . ”) which is underlined to show the selection results in the message text displayed in message text area 202. Embodiments of the invention may display the highest ranked message header's message text in message text area 202 on initial display as the default message text to be viewed. Command area 203 shows available commands in an embodiment of the invention including post, search, next and previous.

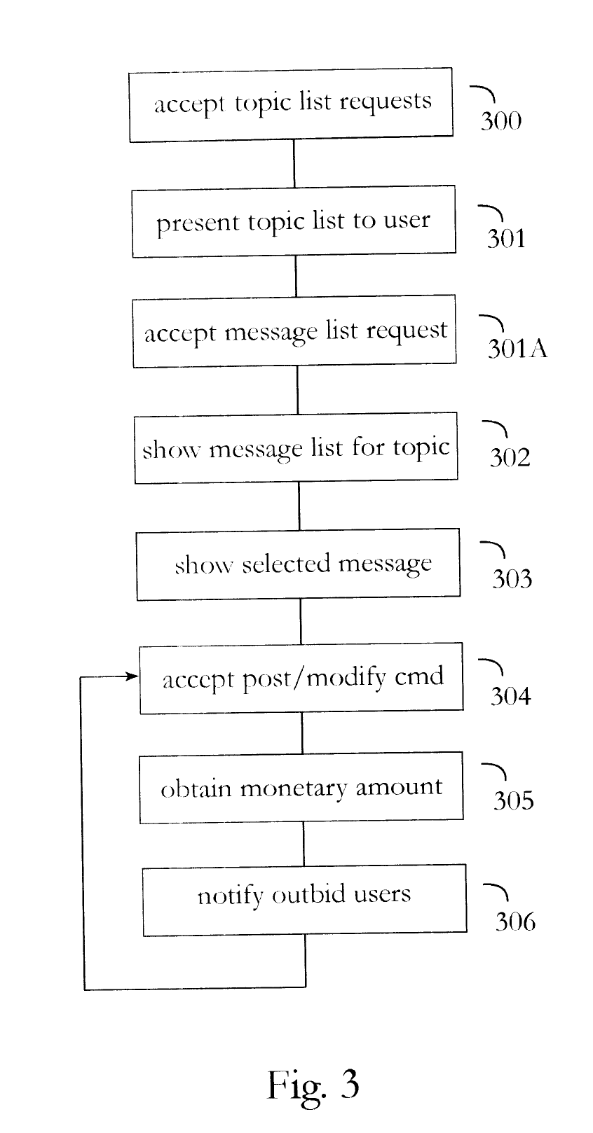

FIG. 3 shows the methodology utilized by an embodiment of the invention directed to bidding for placements. The system accepts requests to view the topic list at 300. Optionally, a user can be authenticated at this point either by cookies, by presentation of a login prompt, by certificate, or by any other methodology of authentication. The user is presented a topic list at 301. The system accepts a message list request for a given topic at 301A although the system may be configured in certain embodiments to default to select the topic and to select and show the message list for the topic containing the highest monetarily ranked message without user intervention. The message header list is sent to the user device for display at 302. The message header list may be initially ranked by bid amount or purchase amount, and the monetary data may or may not be shown in separate embodiments of the invention based on configuration parameters for the topic. The user can optionally search to further reduce the amount of message headers in 302. When the user selects a given message header at 303, the selected message is shown in the message viewing area on the user device. The user may proceed forward or backward through the thread or message header group associated with the selected message at 303. When the user posts a message or decides to modify the message or bid amount on the message at 304, the system accepts the command, saves the information in the database and further obtains the monetary payment amount or bid amount and bid increments at 305. Optionally an external credit card server may be utilized in order to complete the transaction, or the transaction may be completed at a later time. If the payment or bid amount exceeds the amount of other fee amounts of other associated message headers in a single thread or across multiple threads, then the users associated with the message headers that have had their positions altered may be notified at 306 at which time the system proceeds to accept post/modify commands.

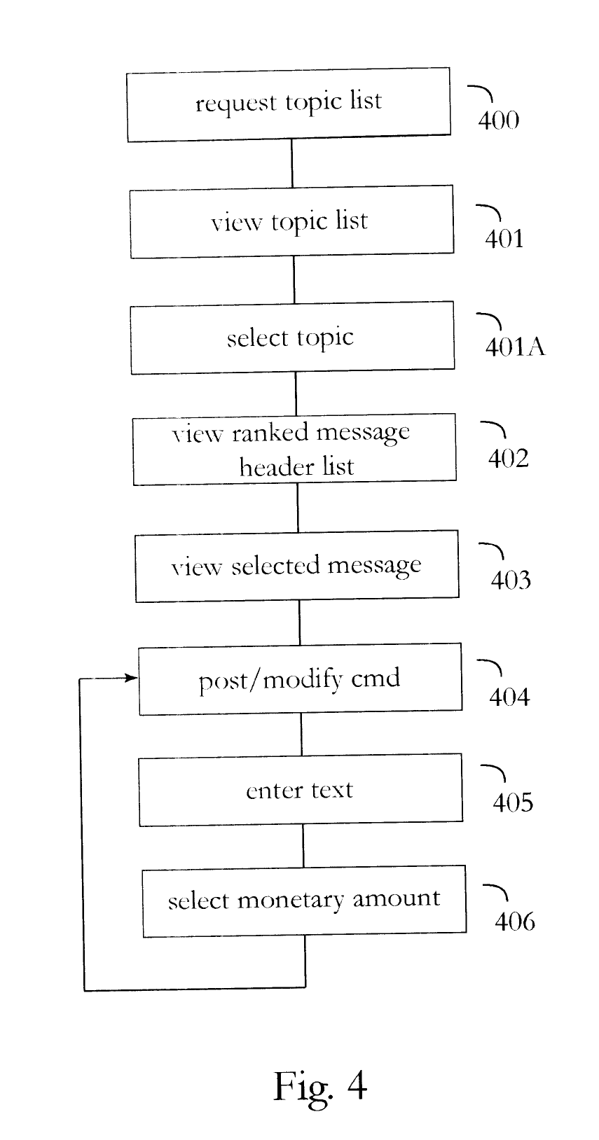

FIG. 4 shows the methodology utilized by users of the system when interacting with an embodiment of the invention. The user initiates a request to view a topic list at 400. The request may be in the form of a Uniform Resource Locator (URL) directed toward a web server or any other type of request for data. Once the data (e.g., list) is provided, the user then views the topic list on a HID at 401. Optionally, a user can be authenticated either by cookies, by entering a username and password, by presentation of a certificate, or by any other methodology of authentication. The user can optionally select one of the topics in the topic list at 401A or in one embodiment of the invention for example, view a topic's ranked message header list at 402 with the corresponding topic selected by the system at 401A as the topic containing the highest monetarily ranked message across all topics. The message header list may be initially ranked by bid amount or purchase amount, and this data may or may not be shown in separate embodiments of the invention based on configuration parameters for the topic. The user can optionally search to further reduce the amount of message headers at 402. The user can optionally select one of the message headers or by default for example be presented with the highest paying message text at 403. When a message is viewed, a fee can be charged to the user and/or paid to the user who posted the message. The fee amounts for viewing a message may be higher or lower than any fee paid to a user who posted a message that is viewed. The user may post or modify a previous post at 404, enter text for the post at 405, and selects a monetary amount associated with the post at 406. Optionally, the user may enter a duration based on any calendar event including weekdays only, weekends only, certain holidays, certain days of the week or any other calendar based event including time ranges for showing the posted message. The user may continue to post and modify posts repeating at 404.

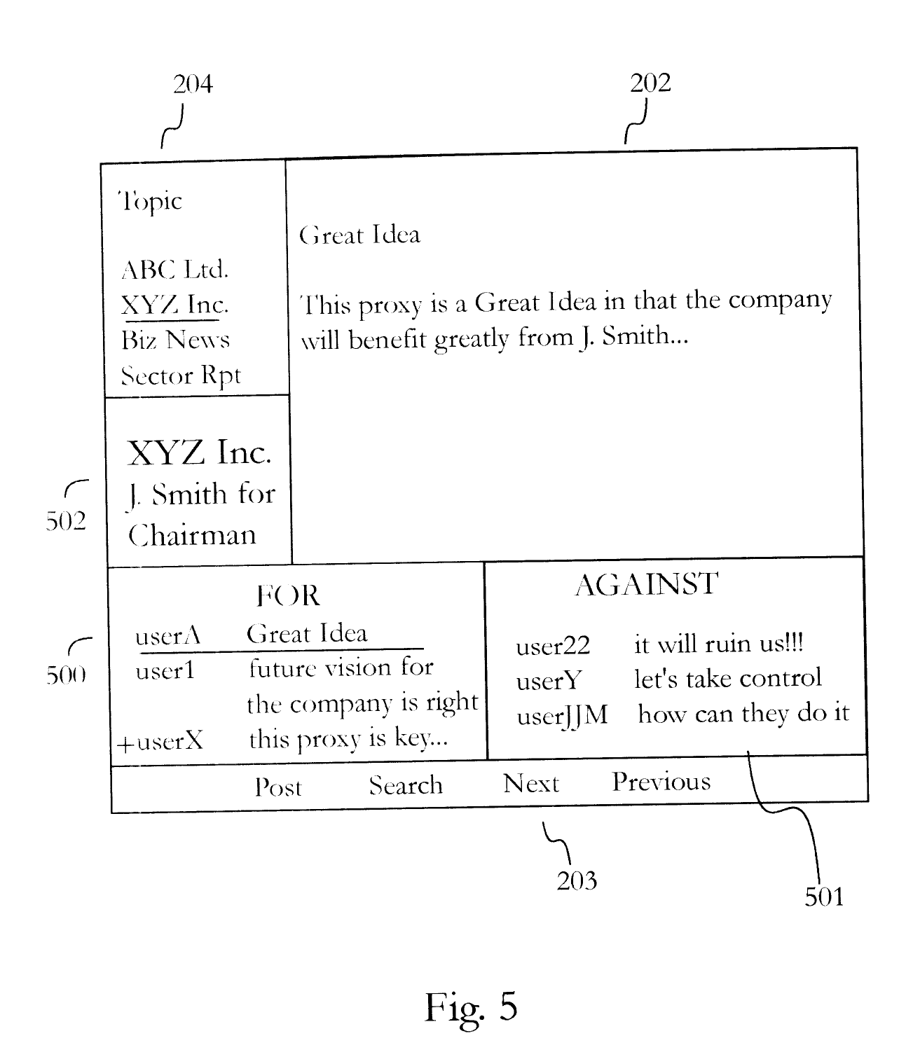

FIG. 5 shows another embodiment of the user interface of the system comprising two message header list areas for use in an application directed towards proxy matters. This embodiment of the invention utilizes two viewing areas 500 and 501 to represent opposing sides of an election (e.g., a proxy vote or political election). Viewing area 500 shows message headers “FOR” the candidate and viewing area 501 shows message headers “AGAINST” the candidate. Topic detail area 502 shows increased information on the topic selected in viewing area 500, shown underlined in this example. The message text for the selected message is shown in message text area 202. The second user posting in viewing area 500 (“user1”) shows an increased message header text field that the user paid an extra fee for. The increased message header text field comprises two lines of text in this example. Larger text areas may be purchased for higher fees in some embodiments of the invention. The default message text displayed in message text area 202 may be configured to be the highest bidding or paying message taken from viewing area 500 or 501 depending on which viewing area associated message had the higher associated monetary value, in this example “userA” in viewing area 500 has bid an amount greater than “user22” in viewing area 501. If viewing area 500 and 501 both have highest value messages of the same amount, an embodiment of the invention may randomly decide which of the two messages to display in message text area 202 or if the user who posted the message is among the highest paying individuals in either column, then the highest value message in that column may be chosen as the default message displayed in message text area 202, or visa versa.

Thus, an exemplary system and method for ranking information in electronic bulletin board systems has been described. The claims however and the full scope of any equivalents are what defines the metes and bounds of the invention.

What is claimed is:

1. A fee based ranking BBS comprising:
a user device;
a network;
a database comprising an author field, a subject field, a date field, a message field and a monetary field; and,
a server configured to run a BBS and process a user command;
said server configured to monetarily rank information stored in said database and present said information via said network to said user device.

2. A method for a fee based ranking BBS comprising:
viewing a topic list;
selecting a topic from said topic list; and,
viewing at least one message header list comprising monetarily ranked message headers.

3. The method of claim 2 further comprising:
posting a first message to said topic; and,
entering a first monetary amount associated with said posting.

4. The method of claim 3 wherein entering comprises bidding up to an amount.

5. The method of claim 3 wherein entering comprises paying a fee for a position.

6. The method of claim 3 further comprising:
selecting a calendar based duration for said posting.

7. The method of claim 3 further comprising:
purchasing an increased message header text field for said posting.

8. The method of claim 3 further comprising:
charging a second user a second monetary amount for viewing said first message.

9. The method of claim 3 further comprising:
paying a first user who posted said first message a third monetary amount when a second user views said first message.

10. The method of claim 3 further comprising:
charging a second user a second monetary amount for viewing said first message; and,
paying a first user who posted said first message a third monetary amount when said second user views said first message.

11. The method of claim 3 further comprising:
notifying a user when a second message is posted to said topic with a second monetary amount which is greater than said first monetary amount associated with said first message.

12. The method of claim 11 wherein notifying comprises polling via the user device.

13. The method of claim 11 wherein notifying comprises sending a message to said user device.

14. The method of claim 3 further comprising:
authenticating a user.

15. The method of claim 3 further comprising:
interacting with an external credit card processing system.

16. The method of claim 3 further comprising:
sharing content with an affiliated BBS.

17. The method of claim 16 further comprising charging said affiliated BBS a fee.

18. The method of claim 16 further comprising paying said affiliated BBS a fee.

19. A computer program product for fee based ranking comprising computer readable program code embodied in a memory medium, said computer readable program code configured to:
display monetarily ranked message header lists in a plurality of viewing areas; and,
display in a message text area a message text corresponding to a highest monetarily ranked message header displayed in one of said plurality of viewing areas.

20. The computer program product of claim 19 further configured to:
accept a post of a first message; and,
obtain monetary ranking information from a first user corresponding to said post.

21. The computer program product of claim 20 further configured to:
accept a time duration for said post.

22. The computer program product of claim 21 further configured to:
notify said first user when a second message is posted having a second monetary amount which is greater than a first monetary amount corresponding to said first message.
